(19) United States
(12) Patent Application Publication
(10) Pub. No.: US 2005/0175073 A1
(43) Pub. Date: Aug. 11, 2005

(54) Data transmission method and transmitter

(76) Inventors: Kari Pajukoski, Oulu (FI); Esa Tiirola, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/098,571

(22) Filed: Apr. 5, 2005

Related U.S. Application Data
(63) Continuation of application No. PCT/FI02/00851, filed on Nov. 1, 2002.

(51) Int. Cl. H04B 1/707

(52) U.S. Cl. 375/146

(57) ABSTRACT

A transceiver and a data transmission method in a telecommunication system are provided. The transmitter is arranged to transmit a WCDMA signal using one or more antennas, the signal comprising one or more code channels. The transmitter receives as input at least one encoded code channel. The transmitter comprises multipliers (308-314) for spreading each code channel with a spreading code, a combiner (324) for combining the spread signals and a converter (328) for performing a serial-to-parallel conversion on the combined signal, obtaining at least two parallel data streams, each parallel data stream corresponding to a given frequency band used in the transmission, and the transmitter is arranged to transmit the signal using simultaneously at least two different frequency bands.

### FIELD

The invention relates to a data transmission method and transmitter in a telecommunications system, where WCDMA is employed.

### BACKGROUND

In most communication systems, several users share a common medium, such as an optical fibre or a radio path. Different multiple access methods have been developed to allow several users to simultaneously use a communication system efficiently. Frequency Division Multiple Access (FDMA), Time Division Multiple Access (TDMA), Orthogonal Frequency Division Multiple Access (OFDMA) and Code Division Multiple Access (CDMA) are three multiple access methods that are widely used in wireless systems. In FDMA, users are separated in time domain. Transmissions of the users are separated by assigning the users different frequency bands. In OFDMA, different symbols of users are transmitted in parallel using many subfrequencies, thus increasing the spectral efficiency as compared with FDMA. In TDMA, users are separated in time domain. Each user is given a time slot, during which it can transmit using the entire channel bandwidth. In CDMA, all users simultaneously share the entire available frequency band. Each user is assigned a unique spreading code. The codes allow a receiver to separate one user from the others although their channel symbols are transmitted simultaneously in the same frequency band. The codes used are selected in such a way that the simultaneously transmitted signals are orthogonal with each other. Thus, ideally, they do not interfere with each other.

Different variants of CDMA have been proposed. In narrow-band CDMA, typically a 200 kHz wide carrier is utilized. In WCDMA (Wideband CDMA), a bandwidth over 1 MHZ is utilised. In a wide bandwidth WCDMA system, the users share a relatively wide bandwidth, typically more than 5 MHz. In a narrow bandwidth CDMA system, the bandwidth is narrower, typically less than 5 MHz. FIGS. 1A and 1B illustrate the frequency allocation principle of wide and narrow bandwidth WCDMA systems.

There is a number of problems in a wider bandwidth WCDMA system. First, the orthogonality of the transmitted signals is partly destroyed in a frequency selective channel. Due to the wide channel, the number of the multipath components and also the respective delays of the components are large. The resulting multiple access interference (intra-cell interference) will cause an error floor when a Rake receiver is used.

Second, only part of the signal energy can be gathered in channels having multiple propagation paths: the amount of exploitable signal energy depends on the power delay profile (PDP) of the radio channel. The problem exists especially if there are a great number of signal multipath components and the power delay profile is exponentially distributed.

The third point is that frequency allocation can be difficult. It may be difficult to find such a wide bandwidth in an environment where many different operators have networks.

The problems of a wide bandwidth WCDMA system may be reduced by decreasing the transmission bandwidth (i.e. chip rate). It is obvious that the orthogonality of the signals is improved when the chip rate is decreased. Also the number of multipath components is reduced since the time resolution of the radio channel is decreased when the chip rate is increased. If, for example, a 10 MHz bandwidth WCDMA system of FIG. 1A were replaced with a narrow bandwidth solution, four separate 2.5 MHz bandwidth WCDMA systems would be needed.

However, also narrow bandwidth WCDMA has some problems as compared to wide bandwidth WCDMA. Common channel overhead is increased when the transmission bandwidth is decreased: all the common channels need to be transmitted via each carrier. In addition, code capacity is decreased when the transmission bandwidth is decreased: in the narrow bandwidth WCDMA system common channels waste channelization codes in multiple carriers. The maximum bit rate/user is limited due to the narrower transmission bandwidth. Finally, load balance may be a problem within narrow bandwidth WCDMA systems.

R. Prasad and S. Hara: “An overview of multi-carrier CDMA,” Proc. IEEE International Symposium on Spread Spectrum Techniques and Applications vol.1, pp.107-114,1996, which is herein included as reference, discloses a solution where a multicarrier CDMA system is proposed. The proposed solution is a combination of CDMA and OFDMA, where a CDMA signal is transmitted using more than one carrier.

### BRIEF DESCRIPTION OF THE INVENTION

It is an object of the invention to provide an improved data transmission method and transmitter. According to an aspect of the invention there is provided a data transmission method in a telecommunication system, the method comprising transmitting a WCDMA signal using one or more antennas, the signal comprising one or more code channels, spreading the WCDMA signal both in frequency and time domains, coding the WCDMA signal only in time domain and transmitting the signal using simultaneously at least two different frequency bands.

According to an aspect of the invention there is also provided a data transmission method in a telecommunication system, the method comprising transmitting a WCDMA signal using one or more antennas, the signal comprising one or more code channels, coding the WCDMA signal both in frequency and time domains, spreading the WCDMA signal only in time domain, and transmitting the signal using simultaneously at least two different frequency bands.

According to an aspect of the invention there is also provided a transmitter in a telecommunication system, arranged to transmit a WCDMA signal using one or more antennas, the signal comprising one or more code channels. The transmitter is further arranged to spread the WCDMA signal both in frequency and time domains, code the WCDMA signal only in time domain and to transmit the signal using simultaneously at least two different frequency bands.

According to an aspect of the invention there is also provided a transmitter in a telecommunication system, arranged to transmit a WCDMA signal using one or more antennas, the signal comprising one or more code channels. The transmitter is further arranged to code the WCDMA signal both in frequency and time domains, spread the WCDMA signal only in time domain, and to transmit the signal using simultaneously at least two different frequency bands.

Preferred embodiments of the invention are described in the dependent claims.

The method and system of the invention provide several advantages. The preferred embodiments provide the benefits from both wide bandwidth and narrow bandwidth WCDMA systems. For example, the common channel overhead is small, maximum bit rate per user is not limited as in narrow bandwidth systems, and the orthogonality of the transmitted signals remains the same as in narrow bandwidth systems.

### LIST OF DRAWINGS

In the following, the invention will be described in greater detail with reference to the preferred embodiments and the accompanying drawings, in which

FIGS. 1A and 1B illustrate examples of WCDMA frequency allocation;

FIG. 2 shows an example of a data transmission system;

FIGS. 3A and 3B illustrate a transmitter according to an embodiment of the invention;

FIG. 4 illustrates a method according to an embodiment;

FIGS. 5A and 5B illustrate a transmitter according to an embodiment of the invention;

FIG. 6 illustrates a method according to an embodiment, and

FIGS. 7A and 7B illustrate receiver embodiments.

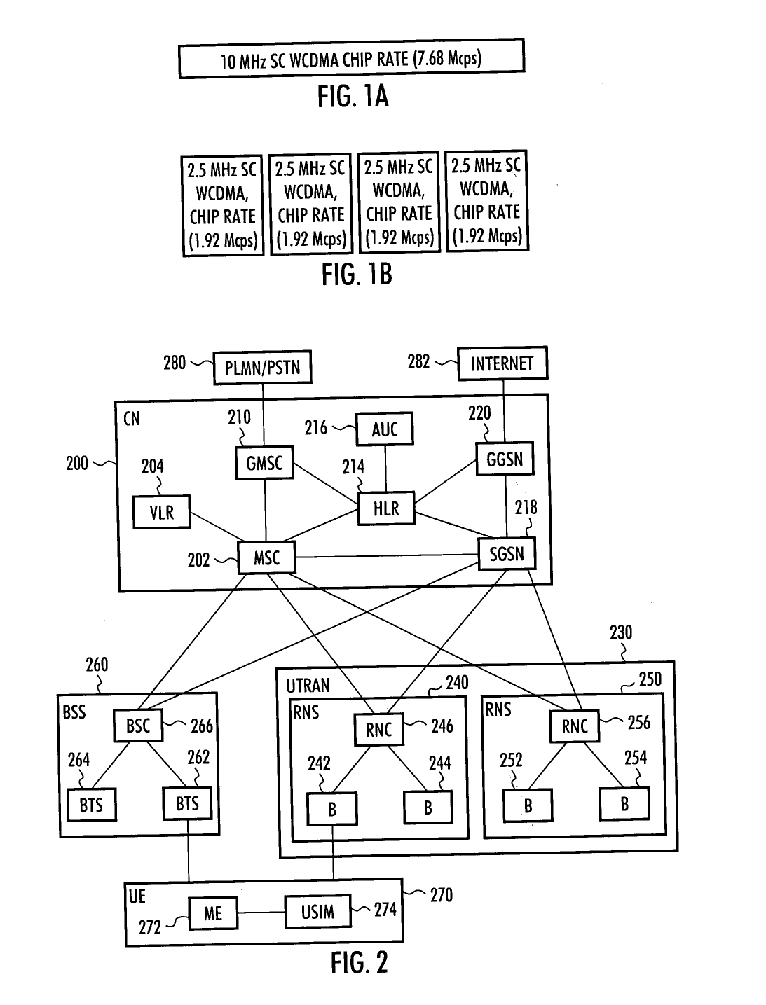

### DESCRIPTION OF EMBODIMENTS

With reference to FIG. 2, examine an example of a data transmission system in which the preferred embodiments of the invention can be applied. FIG. 2 is a simplified block diagram which at a network element level, describes the most important parts of the radio system. The structure and functions of the network elements are not described in detail, because they are commonly known.

In FIG. 2, a core network CN 200 represents the radio-independent layer of the telecommunications system. The radio systems are shown as a first radio system, i.e. a radio access network 230, and a second radio system, i.e. a base station system BSS 260. In addition, the figure shows user equipment UE 270. The term UTRAN comes from the words UMTS Terrestrial Radio Access Network, i.e. the radio access network 230 is implemented using wideband code division multiple access WCDMA. The base station system 260 is implemented using time division multiple access TDMA.

Generally, it is also possible to define that a radio system comprises user equipment, also known as a user device or a mobile phone, and a network part that contains the radio access network or base station system of the fixed infrastructure of the radio system.

The structure of the core network 200 corresponds to a combined GSM and GPRS system structure. The GSM network elements are responsible for providing circuit-switched connections and the GPRS network elements are responsible for providing packet-switched connections, some of the network elements being, however, included in both systems.

A mobile services switching centre MSC 202 is the midpoint of the circuit-switched side of the core network 200. One and the same mobile services switching centre 202 can be used to serve the connections of both the radio access network 230 and the base station system 260. The tasks of the mobile services switching centre 202 include switching, paging, location registration, handover management, collecting subscriber billing information, encryption parameter management, frequency allocation management, and echo cancellation. The number of mobile services switching centres 202 may vary: a small network operator may have only one mobile services switching centre 202, but large core networks 200 usually have several.

Large core networks 200 can have a separate gateway mobile services switching centre GMSC 210, which takes care of the circuit-switched connections between the core network 200 and external networks 280. The gateway mobile services switching centre 210 is located between the mobile services switching centres 202 and the external networks 280. An external network 280 can be a public land mobile network PLMN or a public switched telephone network PSTN, for instance.

A home location register HLR 214 contains a permanent subscriber register, i.e. the following information, for instance: an international mobile subscriber identity IMSI, mobile subscriber ISDN number MSISDN, authentication key, and when the radio system supports GPRS, a PDP (Packet Data Protocol) address.

A visitor location register VLR 204 contains user equipment 270 roaming information in the area of the mobile services switching centre 202. The visitor location register 204 contains mainly the same information as the home location register 214, but in the visitor location register 204 the information is only temporary.

An authentication centre AuC 216 always resides physically at the same location as the home location register 214 and contains an individual subscriber authentication key Ki, ciphering key CK and the corresponding IMSI.

The network elements in FIG. 2 are functional entities whose physical implementation may vary. Ordinarily, the mobile services switching centre 202 and visitor location register 204 form one physical device, and the home location register 214 and authentication centre 216 another physical device.

A serving GPRS support node SGSN 218 is the midpoint of the packet-switched side of the core network 200. The main task of SGSN 218 is to transmit packets to and receive them from user equipment 270 supporting packet-switched transmission by using the radio access network 230 or base station system 260. SGSN 218 contains subscriber and location information concerning the user equipment 270.

A gateway GPRS Support Node GGSN 220 is the packet-switched side counterpart to the gateway mobile services switching centre 210 of the circuit-switched side, with the difference, however, that GGSN 220 must also be capable of routing traffic from the core network 200 to external networks 282, whereas GMSC 210 only routes incoming traffic. In our example, the Internet represents the external networks 282.

The first radio system, i.e. radio access network 230, comprises radio network subsystems RNS 240, 250. Each radio-network subsystem 240, 250 comprises radio network controllers RNC 246, 256 and Nodes B 242, 244, 252, 254. Node B is a rather abstract concept, and often the term base station is used instead.

The radio network controller 246 controls Nodes B 242, 244. In principle, the aim is that the devices providing the radio path and the related functions reside in Nodes B 242, 244 and the control devices reside in the radio network controller 246.

The radio network controller 246 takes care of the following tasks, for instance: radio resource management of Node B 242, 244, inter-cell handovers, frequency management, i.e. the allocation of frequencies to Nodes B 242, 244, management of frequency hopping sequences, measurement of time delays on the uplink, provision of the operation and maintenance interface, and power control.

Node B 242, 244 comprises one or more transceivers, with which the WDCMA radio interface is provided. Node B serves one cell, but it can also serve several sectored cells. The diameter of a cell may vary from a few metres to dozens of kilometres. The tasks of Node B 242, 244 include: timing advance calculation, uplink measurements, channel coding, encryption and decryption.

The second radio system, i.e. a base station system 260, comprises a base station controller BSC 266 and base stations BTS 262, 264. The base station controller 266 controls the base stations 262, 264. In principle, the aim is that the devices providing the radio path and the related functions reside in the base stations 262, 264 and the control devices reside in the base station controller 266. The base station controller 266 takes care basically of the same tasks as the radio network controller.

The base station 262, 264 contains at least one transceiver, which provides one carrier, i.e. eight time slots, i.e. eight physical channels. Typically, one base station 262, 264 serves one cell, but it can also serve several sectored cells. The base station 262, 264 also comprises a transcoder that converts between the speech coding formats used in the radio system and the public telephone network. However, in practice, the transcoder usually resides physically in the mobile services switching centre 202. The tasks of the base station 262, 264 correspond to those of Node B.

Both Node B 242, 244 and base station 262, 264 may utilise spatial diversity, i.e. use an array antenna in the signal reception (and also transmission). An antenna array may comprise a plural number of antenna elements physically separate from each other. The received signals are combined in diversity receivers using a suitable combining method.

The user equipment 270 comprises two parts: mobile equipment ME 272 and UMTS subscriber identity module USIM 274. The user equipment 270 contains at least one transceiver that provides a radio link to the radio access network 230 or base station system 260. The user equipment 270 may contain at least two different user identity modules. In addition, the user equipment 270 contains an antenna, user interface and a battery. Currently, there are different types of user equipment 270, those installed in cars and portable equipment, for instance.

USIM 274 contains user-related information and particularly information related to information security, such as an encryption algorithm.

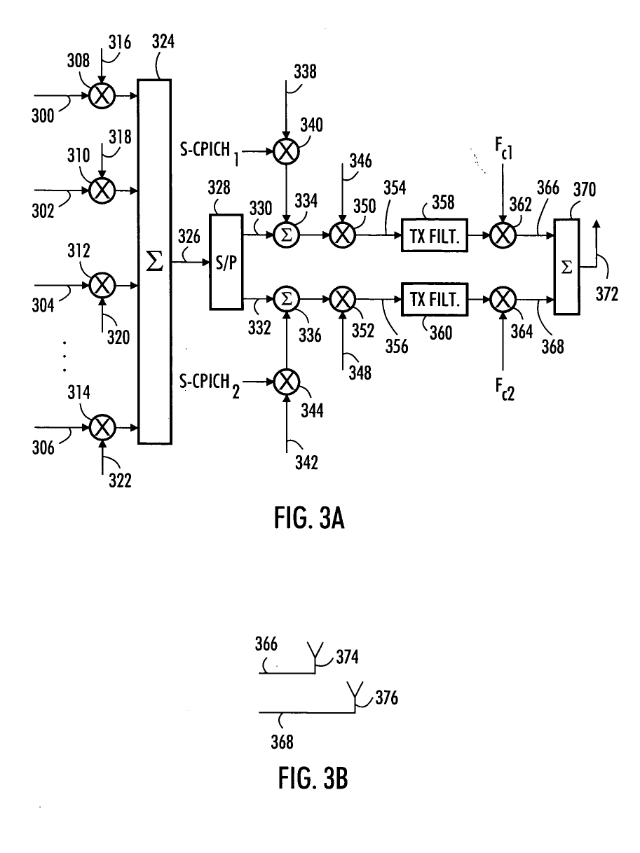

A transmitter according to an embodiment of the invention is illustrated in FIG. 3A. A fully functional transmitter also comprises other elements than those described in the figure, such as filters, amplifiers, control unit, etc., but as these elements are not essential with respect to the embodiment they are not described here. The transmitter may be a part of a transceiver comprising a receiver and a transmitter. The transmitter may be a part of a base station unit and be responsible for transmission of several users' signals. A transceiver may also comprise a user interface. The user interface may comprise a microphone, a display, a speaker and a keyboard. The user interface may also be realized in many other ways, as is evident for one skilled in the art. Furthermore, the signals to be transmitted may be generated in an external device, such as a computer connected to the transmitter.

Let us here assume that the transmission in this example is performed using two different or non-overlapping frequency bands, the total bandwidth of the bands being 2.5 GHz and the capacity of each frequency band being 3.84 Mcps (mega chips per second). The transmitter of this embodiment may be called a Multi Carrier WCDMA (MC-WCDMA) transmitter. In this embodiment, the WCDMA signal is spread both in frequency and time domains, but coding is performed only in time domain.

The transmitter comprises signal inputs 300 to 306. At the inputs 300 to 306 of the transmitter, are encoded symbols of different code channels. These signals may be signals of one or several users. Each signal is multiplied in multipliers 308 to 314 by spreading codes 316 to 322. The spreading codes used are selected such that the multiplied signals are orthogonal with each other. The spreading ratio of each coded signal depends on the service used. For example, the spreading ratios of a video transmission service and a speech service differ from each other.

The multiplied signals are summed in a summer 324. In this example, the chip rate of the signal at this point is 7.68 Mcps. The summed signal 326 is conveyed to a serial to parallel converter 328. In this example, the summed signal is converted to two parallel signals 330, 332. The number of parallel signals may also be more than two. The chip rate of both parallel signals at this point is 3.84 Mcps.

To each parallel signal is added a common pilot S-CPICH₁, S-CPICH₂ in summers 334, 336. Before the addition the pilot signal S-CPICH₁ is multiplied by a spreading code 338 in multiplier 340 and the pilot signal S-CPICH₂ is multiplied by a spreading code 342 in multiplier 344, respectively.

Each parallel signal is further multiplied by a scrambling code 346, 348 in multipliers 350, 352. This scrambling code corresponds to a channel code in each sector or cell used. The code may be the same in different parallel signals. Next, the scrambled signals 354, 356 are filtered in transmission filters 358, 360 and multiplied in multipliers 362, 264 by carrier frequencies f_{c1} and f_{c2}. After this multiplication the parallel signals 366, 368 are thus on different frequency bands, which are selected such that they do not overlap with each other.

The parallel signals 366, 368 are summed in a summer 370 and transmitted using an antenna 372. In another embodiment, illustrated by FIG. 3B, the signals 366, 368 are not summed but, instead, transmitted using separate antennas 374, 376.

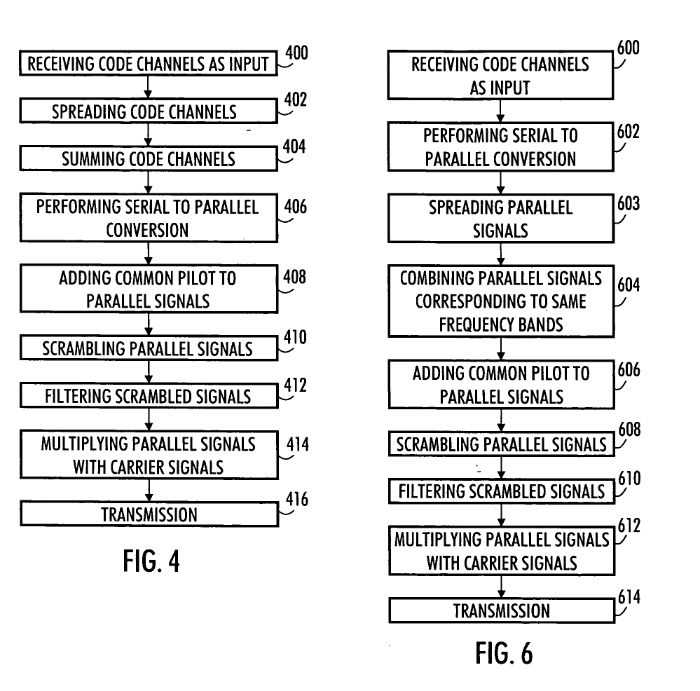

A method according to an embodiment of the invention is illustrated in a flowchart in FIG. 4. It should be noted that not all steps shown are necessarily needed in every embodiment.

In the first step 400, at least one encoded code channel is received as input in the transmitter. Next, each code channel is spread 402 with a spreading code such that after the spreading, the signals are orthogonal with each other. In the following step 404 the spread signals are summed.

Next, a serial-to-parallel conversion is performed 406 on the summed signal, obtaining at least two parallel data streams where each parallel data stream corresponds with a given frequency band used in the transmission. A common pilot signal is added 408 to each data stream. In the next step 410, each data stream is scrambled with a scrambling code, after which each scrambled data stream is filtered 412 with a transmission filter. The filtered signals are converted 414 up to a given frequency by multiplying the signals with a carrier signal. Finally, the signals are transmitted 416 with at least one antenna.

In this embodiment, frequency diversity over frequency bands is utilised. The amount of diversity depends on the fading correlation between frequency bands. The orthogonality of the solution at frequency band domain is better than in wide band WCDMA systems. Space Time Transmit Diversity (STTD) per frequency band may also be utilised to further increase the amount of diversity. As the chip rate per frequency band is lower than in the wide bandwidth WCDMA, the chip duration is longer. Thus, synchronisation may be easier.

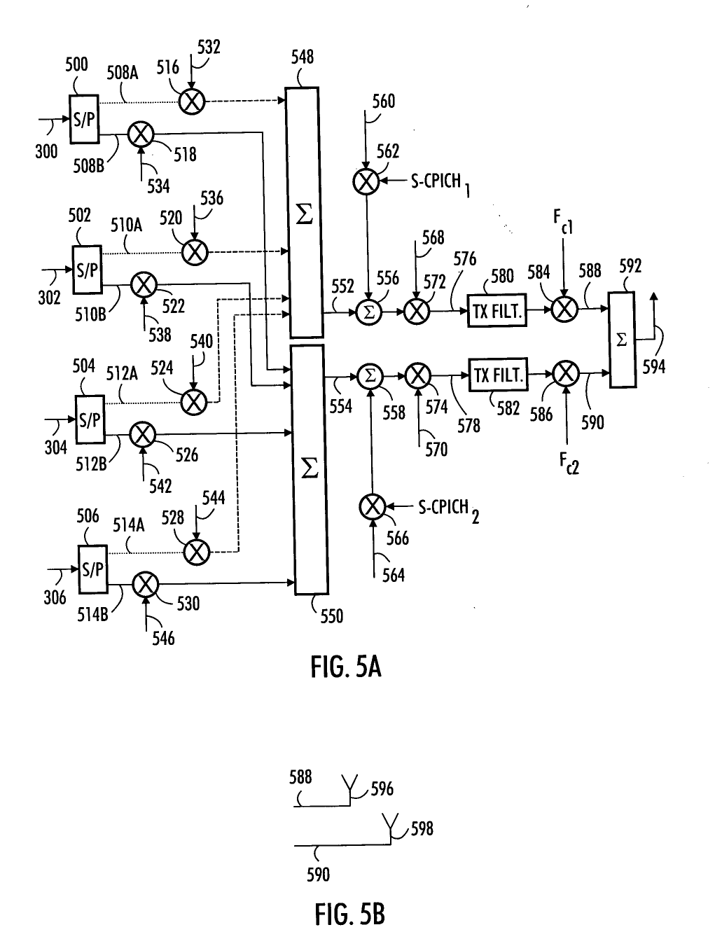

A transmitter according to another embodiment of the invention is illustrated in FIG. 5A. As with the embodiment of FIG. 3A, a fully functional transmitter may also comprise other elements than those described in the figure. The transmitter may be a part of a transceiver comprising a receiver and a transmitter. The transmitter may be a part of a base station unit and be responsible for transmission of several users' signals.

Let us again assume that the transmission in this example is performed using two different or non-overlapping frequency bands, the total bandwidth of the bands being 2.5 GHz and the capacity of each frequency band being 3.84 Mcps (mega chips per second). The transmitter of this embodiment may be called a Multi Carrier Direct Sequence WCDMA (MC-DS-WCDMA) transmitter. In this embodiment, coding is performed on a WCDMA signal both in frequency and time domains but spreading only in time domain.

The transmitter comprises signal inputs 300 to 306. At the inputs 300 to 306 of the transmitter, are encoded symbols of different code channels. These signals may be signals of one or several users. Each signal 300 to 306 is taken to a parallel to serial converter 500 to 506. In this example, each parallel to serial converter converts the input signal into two parallel signals, 508A to 514A and 508B to 514B. The number of parallel signals may also be more than two. Preferably, the number of parallel signals corresponds to the number of frequency bands used in transmission.

Each parallel signal is multiplied in multipliers 516 to 530 by spreading codes 532 to 546. After multiplication, the signals are orthogonal with each other. The spreading ratio of each coded signal again depends upon the service used.

The multiplied signals are summed in summers 548 and 550 such that each parallel signal from each code channel is taken to a different summer. Thus, in this example, signals 508A, 510A, 512A and 514A are taken to summer 548, and signals 508B, 510B, 512B and 514B are taken to summer 550, respectively. The summed signals 552, 554 are conveyed to summers 556, 558, respectively, where a common pilot is added to each signal. The pilot signal S-CPICH₁, which is added to signal 552, is multiplied before the addition by a spreading code 560 in multiplier 562 and the pilot signal S-CPICH₂, which is added to signal 552, is multiplied by a spreading code 564 in multiplier 566, respectively.

In this example, the chip rate of the signals at this point is 3.84 Mcps. Each parallel signal is further multiplied by a scrambling code 568, 570 in multipliers 572, 574. This scrambling code corresponds to a channel code in each sector or cell used. The code may be the same in different parallel signals. Next, the scrambled signals 576, 578 are filtered in transmission filters 580, 582 and multiplied in multipliers 584, 586 by carrier frequencies f_{c1} and f_{c2}. After this multiplication the parallel signals 588, 590 are thus on different frequency bands, which are selected such that they do not overlap with each other.

The parallel signals 588, 590 are summed in a summer 592 and transmitted using an antenna 594. In another embodiment, illustrated by FIG. 5B, the signals 588, 590 are not summed but, instead, transmitted using separate antennas 596, 598.

A method according to an embodiment of the invention is illustrated in a flowchart in FIG. 6. It should be noted that not all steps shown are necessarily needed in every embodiment.

In the first step 600, at least one encoded code channel is received as input in the transmitter. Next, a serial-to-parallel conversion is performed 602 on the code channel signals obtaining at least two parallel data streams from each code channel, the number of parallel data streams per code channel corresponding with the number of frequency bands used in the transmission. In the next phase, the parallel data streams are multiplied 603 by spreading codes. After multiplication, the signals are orthogonal with each other. Next, all the parallel data streams corresponding to the same frequency bands are combined 604, thus obtaining at least two parallel data streams. Next, a common pilot signal is added 606 to each parallel data stream.

In the next step 608, each parallel stream is scrambled with a scrambling code, after which each scrambled data stream is filtered 610 with a transmission filter. The filtered signals are converted 612 up to a given frequency by multiplying the signals with a carrier signal. Finally, the signals are transmitted 614 with at least one antenna.

In this embodiment, frequency diversity over frequency bands is not utilised. The orthogonality of the solution at frequency band domain is better than in wide band WCDMA systems. Space Time Transmit Diversity (STTD) per frequency band may also be utilised to further increase the amount of diversity. As in the previous embodiment, the chip rate per frequency band is lower than in wide bandwidth WCDMA and thus synchronisation may be easier.

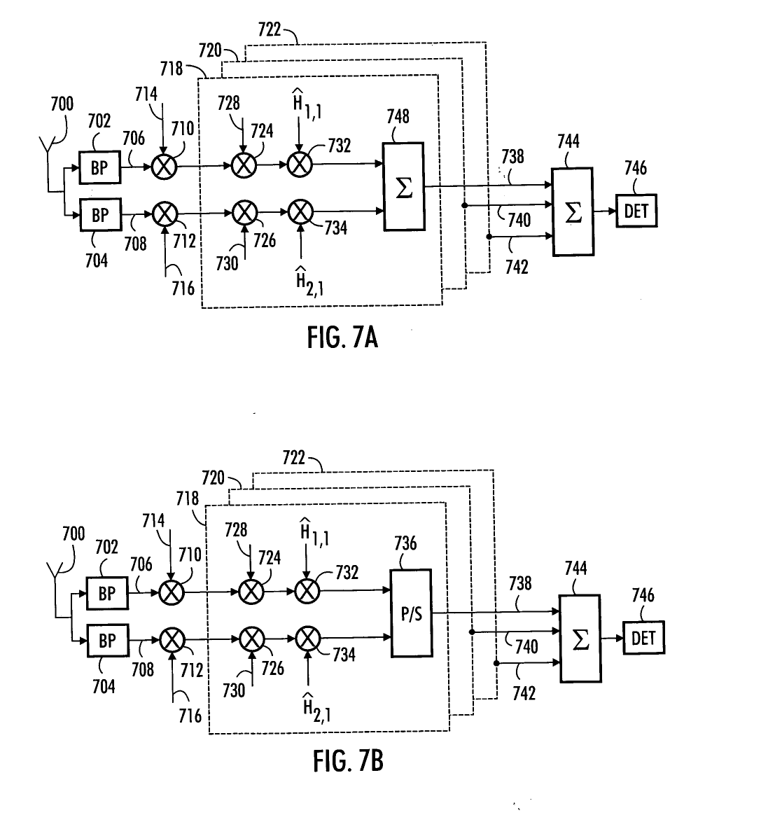

An MC-DC-WCDMA receiver according to an embodiment of the invention is illustrated in FIG. 7A. As with the transmitter embodiments, a fully functional receiver may also comprise other elements than those described in the figure. The receiver may be a part of a transceiver comprising a receiver and a transmitter. The receiver may be a receiver in mobile user equipment or a part of a base station unit and be responsible for transmission of several users' signals.

The receiver comprises at least one antenna 700 for signal reception. The received signal is taken to at least two band pass filters 702, 704 where each band pass filter corresponds to a given carrier frequency. Each filtered signal 706, 708 thus comprises the signal transmitted using one carrier frequency. The signals are taken to multipliers 710, 712, where the signals are descrambled with scrambling codes 714, 716. The codes correspond to the codes used in transmission scrambling.

The receiver of the embodiment comprises one or more rake fingers, which process received signal components. A typical rake receiver further comprises a searcher finger, which measures the delay profile of the received signal. The differently delayed signal components may be allocated to different rake fingers. This structure of a rake receiver is well known to one skilled in the art and is not disclosed in FIG. 7A.

Thus, the descrambled signals are taken to rake fingers 718 to 722 of the receiver. Each rake finger processes one signal component, which comprises signals of all carrier frequencies. In this example, the descrambled signal components delayed in the radio channel with a given delay are taken to rake finger 718. The signals are despread by multiplying the signals in multipliers 724, 726 by spreading codes 728, 730. The codes correspond to the codes used in transmission spreading. After the despreading, the signals are multiplied in multipliers 732, 734 by channels estimates ĥ_{1,1} and ĥ_{1,1}, which are obtained from the common pilot signals S-CPICH. The calculation of the estimate is well known to one skilled in the art and is not disclosed in FIG. 7A. The output signals of the multipliers are taken to a parallel to serial converter 736 which converts the signal in to serial form.

The output signals 738 to 742 from each rake finger are summed in summer 744 and taken to the detection stage 746 of the receiver.

An MC-WCDMA receiver according to an embodiment of the invention is illustrated in FIG. 7B. The receiver is otherwise similar to the receiver of FIG. 7A with the exception of the operation of the rake fingers 718 to 722. In the despreading, the despreading code of MC-WCDMA is obtained by taking every second bit of the actual spreading code. In MC-DC-WCDMA every bit is taken. Furthermore, the output signals of the multipliers 732, 734 are, instead of the parallel to serial converter summed in a summer 748. The summed signals 738 to 742 of rake fingers are taken into the summer 744 as in FIG. 7A.

Even though the invention has been described above with reference to an example according to the accompanying drawings, it is clear that the invention is not restricted thereto but can be modified in several ways within the scope of the appended claims.

1. A data transmission method in a telecommunication system, the method comprising
transmitting a WCDMA signal using one or more antennas, the signal comprising one or more code channels,
spreading the WCDMA signal both in frequency and time domains,
coding the WCDMA signal only in time domain, and
transmitting the signal using simultaneously at least two different frequency bands.

2. The method of claim 1, further comprising:
receiving as input at least one encoded code channel in the transmitter,
spreading each code channel with a spreading code,
combining the spread signals, and
performing a serial-to-parallel conversion on the combined signal, obtaining at least two parallel data streams, each parallel data stream corresponding to a given frequency band used in the transmission.

3. A data transmission method in a telecommunication system, the method comprising
transmitting a WCDMA signal using one or more antennas, the signal comprising one or more code channels,
coding the WCDMA signal both in frequency and time domains,
spreading the WCDMA signal only in time domain, and
transmitting the signal using simultaneously at least two different frequency bands.

4. The method of claim 3, further comprising:
receiving as input at least one encoded code channel in the transmitter,
converting each code channel into at least two parallel data streams, each parallel data stream of a code channel corresponding to a given frequency band used in the transmission,
spreading each parallel data stream with a spreading code, and
combining all the parallel data streams corresponding to the same frequency bands.

5. The method of claim 2, further comprising:
adding a common pilot signal to each data stream corresponding to a frequency band,
scrambling each data stream with a scrambling code,
filtering each scrambled data stream, and
converting each filtered data stream up to a given frequency.

6. The method of claim 5, further comprising: transmitting at least two different frequency bands using separate antennas.

7. The method of claim 5, further comprising: combining the up-converted data streams and transmitting the combined signal using an antenna.

8. A transmitter in a telecommunication system, arranged to transmit a WCDMA signal using one or more antennas, the signal comprising one or more code channels,
spread the WCDMA signal both in frequency and time domains,
code the WCDMA signal only in time domain, and to
transmit the signal using simultaneously at least two different frequency bands.

9. The transmitter of claim 8, further comprising:
means for receiving as input at least one encoded code channel in the transmitter,
means for spreading each code channel with a spreading code,
means for combining the spread signals, and
means for performing a serial-to-parallel conversion on the combined signal, obtaining at least two parallel data streams, each parallel data stream corresponding to a given frequency band used in the transmission.

10. A transmitter in a telecommunication system, arranged to transmit a WCDMA signal using one or more antennas, the signal comprising one or more code channels,
code the WCDMA signal both in frequency and time domains,
spread the WCDMA signal only in time domain, and to
transmit the signal using simultaneously at least two different frequency bands.

11. The transmitter of claim 10, further comprising:
means for receiving as input at least one encoded code channel in the transmitter,
means for converting each code channel into at least two parallel data streams, each parallel data stream corresponding to a given frequency band used in the transmission,
means for spreading each parallel data stream with a spreading code and
means for combining all the parallel data streams corresponding to the same frequency bands.

12. The transmitter of claim 9, further comprising:
means for adding a common pilot signal to each data stream corresponding a frequency band,
means for scrambling each data stream with a scrambling code,
means for filtering each scrambled data stream, and
means for converting each filtered data stream up to a given frequency.
